(19) United States
(12) Patent Application Publication
(10) Pub. No.: US 2026/0094508 A1
(43) Pub. Date: Apr. 2, 2026

(54) VISION-BASED SELF-SERVICE CHECKOUT SYSTEM AND METHOD FOR IDENTIFYING PACKAGED PRODUCTS AND PRODUCE

(71) Applicant: NCR Voyix Corporation, Atlanta, GA (US)

(72) Inventors: Kip Oliver Morgan, Atlanta, GA (US); Gina Torcivia Bennett, Lawrenceville, GA (US); Jerry Steven Massey, Lawrenceville, GA (US); John Kennedy, Lawrenceville, GA (US)

(21) Appl. No.: 18/901,468

(22) Filed: Sep. 30, 2024

(51) Int. Cl. G07G 1/00; G06V 10/70; G07G 1/06

(52) U.S. Cl. CPC G07G 1/0072; G06V 10/70; G07G 1/06

(57) ABSTRACT

A self-service checkout system forwards output images from a set of cameras having a predefined field of view focused on a checkout tray to a machine learning model trained to identify packaged items and suggested produce items. The machine learning model determines that an item on the checkout tray is a produce item or one or more packaged items. When the item is one or more packaged items, an identification of each of the one or more packaged items is received from the machine learning model and the identification thereof is added to a list of items to be purchased. When the item is a produce item, a list of suggested produce items is received from the machine learning model, the list of suggested produce items is provided to the user, and, when the user selects an item from the list, the selected produce item is added to the list.

### FIELD

This disclosure relates generally to a system and method for a vision-based self-service checkout system, and more particularly to a vision-based self-service checkout system adapted for use in identifying packaged products and produce.

### BACKGROUND

Self-service checkout terminals allow a customer to perform the checkout process without the need for any assistance from a cashier or other type of attendant. A first type of such terminal may include a vision system that enables automated item recognition, item tracking, and transaction handling in a self-service checkout environment. The vision system uses cameras and associated software to capture image data of items and analyze and interpret the captured image data to identify the items. During the use of such terminals, the customer places some or all of the items to be purchased onto a checkout tray that is completely within the field of view of the several cameras in the vision system. This first type of terminal allows more than one pre-packaged item to be placed on the checkout tray at a time. A second type of such terminal includes a vision system that assists in identifying a produce item placed on the checkout tray that incorporates an integrated scale for weighing such item. This type of system scans the item visually and provides the customer with a list of choices for such item, and, once the correct type is selected by the customer, weighs the item (if sold on the basis of weight). This second type of system only allows one produce item to be placed on the checkout tray at a time.

The present disclosure describes a technical solution that provides a vision-based self-service checkout terminal which can process both pre-packaged items and produce items.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a block diagram of a system according to an aspect of the current disclosure;

FIG. 2 is a functional drawing of a vision-based self-service checkout terminal for use in the system of the current disclosure;

FIG. 3 is a block diagram of the memory organization for the vision-based self-service checkout terminal of the current disclosure;

FIG. 4 is a block diagram of the memory organization for a local for use in the system of the current disclosure; and

FIG. 5 is a flowchart of a method of operation of the system of the current disclosure;

### DETAILED DESCRIPTION

In the present disclosure, like reference numbers refer to like elements throughout the drawings, which illustrate various exemplary embodiments of the present disclosure.

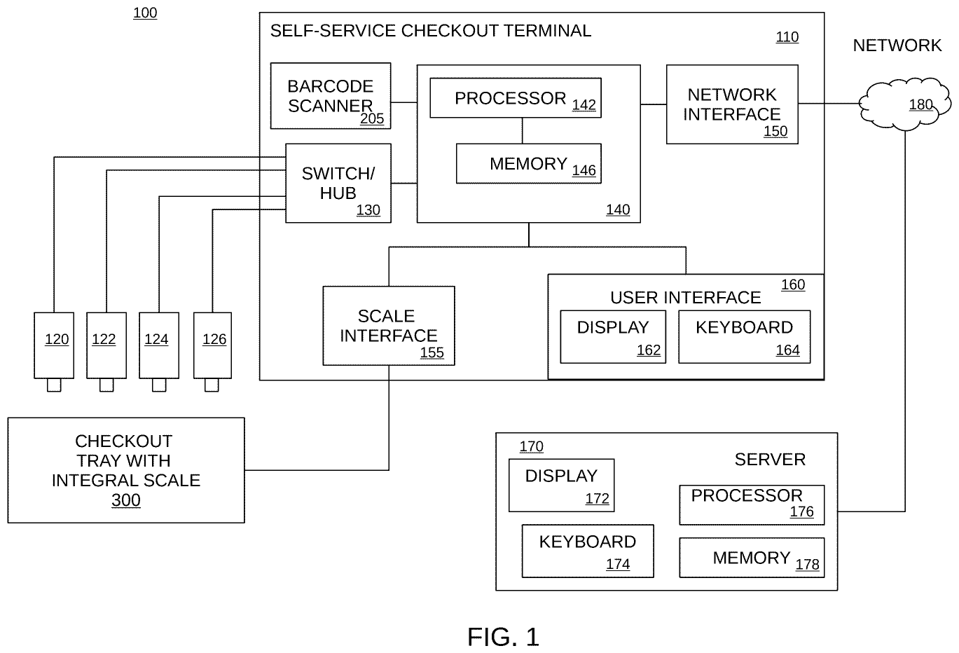

The present disclosure describes an improved vision-based self-service checkout system that enables a customer to perform self-service checkout for both packaged items and produce. Referring now to FIG. 1, system 100 includes a self-service checkout terminal 110 (computing device) with computer vision for use with system and method of the present invention is shown connected to a network 180. Terminal 110 is coupled to a set of cameras (e.g., four cameras 120, 122, 124, 126 are shown in FIG. 1) that are mounted in different positions to focus on a scan zone (in particular a checkout tray 300) of the self-service checkout terminal. Because they are mounted in different positions, each of the cameras 120, 122, 124, 126 will have a different view of the scan zone for the terminal, so that the scan zone will have a particular predefined position within the field of view of each of the cameras 120, 122, 124, 126. Each of the cameras 120, 122, 124, 126 is preferably a network camera (as is known in the art) that is coupled to the computing section 110 via a network switch/hub 130 and transmits the output video image in a digital format over the network. In other embodiments, the cameras 120, 122, 124, 126 may have a composite video output that are each provided to a video switch and digitizer (not shown) within the computing section 110 for further processing and/or viewing (i.e., converting the video signals to digital images).

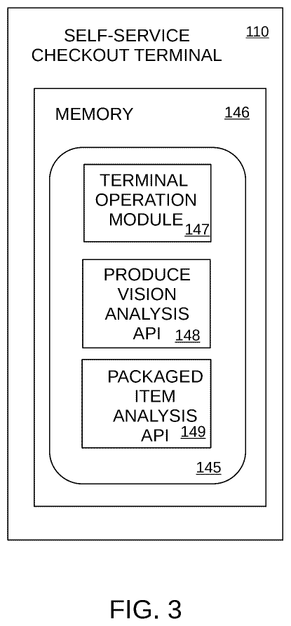

The network switch/hub 130 is coupled to a processing portion 140 of terminal 110. The processing portion 140 includes a processor 142 and a memory 146. Memory 146 includes both a volatile (RAM) portion and a nonvolatile (non-transitory computer readable storage medium) portion 145 (FIG. 3). As shown in FIG. 3, the nonvolatile memory portion 145 includes a terminal operation module 147, a produce vision analysis application programming interface (API) 148, and a packaged item analysis API 149. The terminal operation module 147 provides the functionality to operate the terminal. The produce vision analysis API 148 and the packaged item analysis API 149 serve to communicate with the machine learning model, as explained below, in order to identify produce and packaged items, respectively. Terminal 110 may include more than one processing portion, e.g., one portion for processing the camera images and performing analysis thereof, and another portion for operating the checkout functions of the terminal. The processing portion 140 is coupled to a user interface 160 for input/output that includes, inter alia, a display 162 (which may be a touch-screen display) and a keyboard 164 (or other type of data entry device). The user interface 160 is used during normal operations of the terminal 110. The processing portion 140 may also be coupled to a barcode scanner 205 for use when the vision system is unable to identify an item.

The checkout tray 300 includes an integrated digital scale that provides a digital output signal (representing the weight of any items on the surface of the checkout tray 300) to the processing portion 140 via a scale interface 155. The checkout tray 300 preferably is formed with a non-reflective outer surface in order to improve the identification of items placed thereon.

Computing section 110 also includes a network interface 150 coupled to processing portion 140 and further coupled to a network 180 at a retail store site.

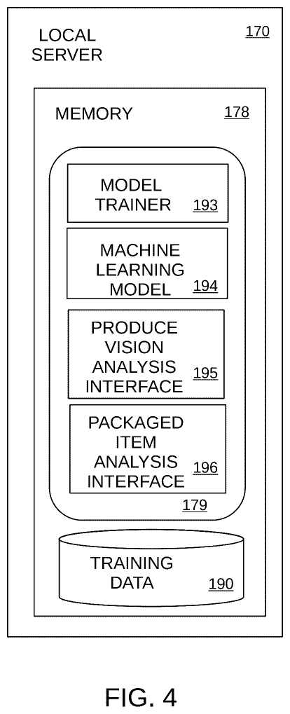

A server 170 may be coupled to the network 180. Server 170 may be located locally at the retail location and manage all of the terminals 110 at that particular retail location or may be located remotely, e.g., cloud-based. The server 170 includes, inter alia, a processor 176, a memory 178, a display 172, and a keyboard (or other user input device) 174. Memory 174 includes both a volatile (RAM) portion and a nonvolatile (non-transitory computer readable storage medium) portion 179 (FIG. 4). As shown in FIG. 4, the nonvolatile memory portion 179 includes a produce vision analysis interface 195, a packaged item analysis interface 196, a model trainer 193, and a machine learning model 194. The produce vision analysis interface 195 communicates with the produce vision analysis API 148 in the terminal 110 to receive information to be provided as in input to the machine learning model 194 and receives the output from the machine learning model 194 for transmission back to the produce vision analysis API 148. The packaged item analysis interface 196 communicates with the packaged item analysis API 149 in the terminal 110 to receive information to be provided to the machine learning model 194 and receives the output from the machine learning model 194 for transmission back to the packaged item analysis API 149. The model trainer 193 operates to train the machine learning model 194 to identify produce and packaged items using training data 190. Memory 178 may also include the training data 190 for use by the model trainer 193 to train the machine learning model 194.

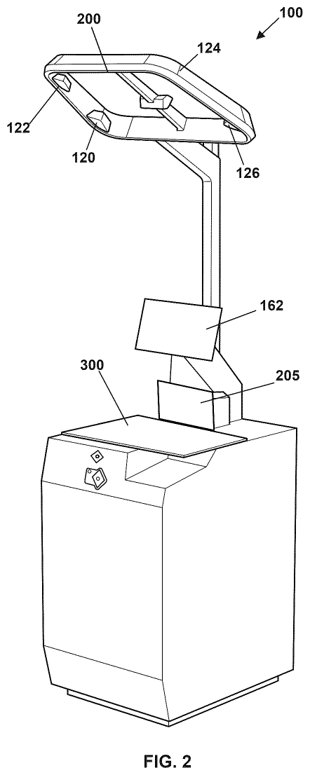

Referring now to FIG. 2, a functional drawing of the vision-based self-service checkout terminal 110 shows two cameras 120, 122 mounted on a structure 200 while the other two cameras 124, 126 are positioned inside the structure 200 at the points shown in FIG. 2. As discussed above, the cameras 120, 122, 124, 126 are positioned to provide a view of the checkout tray 300. The vision-based self-service checkout terminal 110 also includes the display 162 and the bar-code scanner 205.

The model trainer 193 trains the machine learning model 194 to identify produce and packaged items using training data 190. The training data 190 consists of images of the packaged items and produce sold at the retail location. Although a single machine learning model 194 is shown in FIG. 4, separate models can also be used, one for produce identification and another for packaged items. Furthermore, one or both of the models may have sequential portions, with an initial portion performing a coarse determination and a final portion performing the final determination.

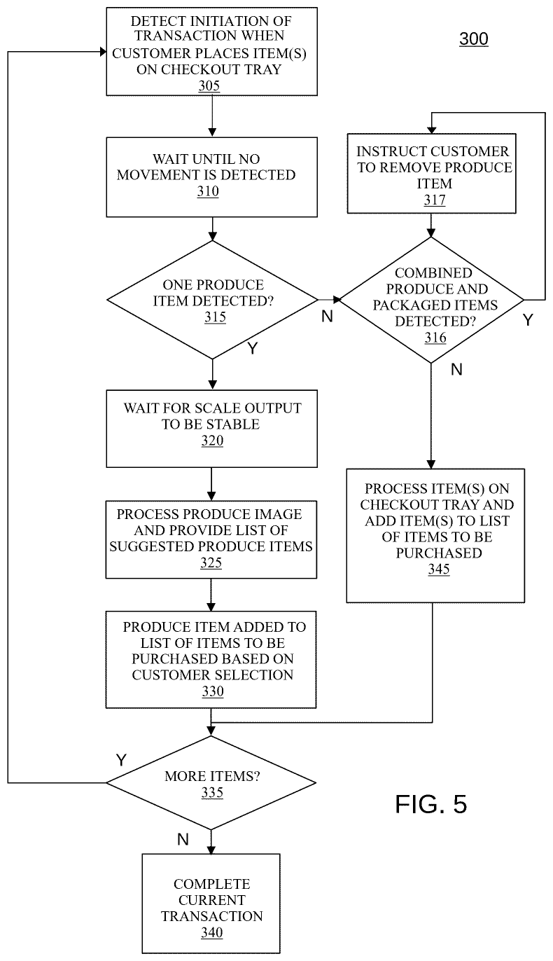

Referring now to the flowchart 300 of FIG. 5, the vision-based self-service checkout terminal 110 detects the initiation of a transaction as the customer begins to place one or more items on the checkout tray 300 at step 305. The terminal 110 pauses until no movement is detected by the cameras, step 310, and then determines if produce is present on the checkout tray 300 at step 315. This is done by providing the images generated by the cameras to the machine learning model via the produce vision analysis API 148, as described above. The customer may be instructed, in one embodiment for example, to only put a single item of produce on the checkout tray 300 or multiple packaged items, in order for the terminal 110 to more accurately make the determination at step 315.

If no produce is detected, processing proceeds to step 345, where the terminal 110 sends images generated by the cameras to the machine learning model via the packaged item vision analysis API 149, as described above, and receives information back from the machine learning model 194 identifying each of the packaged items on the checkout tray. Each identified item is added to a list of items to be purchased, and processing proceeds to step 335. This list may be presented to the customer on the display 162 to allow the customer to check for any mis-identified items.

If produce is detected, processing proceeds to step 320, where the terminal pauses until the output from the scale in checkout tray 300 reaches a stable output. Once the scale reaches a stable output, the terminal 110 sends the images generated by the cameras to the machine learning model via the produce vision analysis API 148, as described above, and receives information back from the machine learning model 194 providing a list of suggested produce items that the terminal 110 provides as a list on the display 162. The customer selects the appropriate produce item at step 330 and terminal 110 adds the item to the list of items to be purchased, calculating the price based on the measured weight from the scale in checkout tray 300 if the item is sold on the basis of weight. For example, each possible produce item has a unit price per weight. Once the item is added to the list of items to be purchased and the corresponding price, processing proceeds to step 335. If the terminal 110 does not identify the proper type of produce item, terminal 110 provides the ability for the customer to select the proper type of produce item through a series of menus as known in the art.

At step 335, the customer is queried to determine whether more items need to be processed, and if so, processing reverts to step 305. If all items have been processed, processing moves to step 340, where the customer completes the transaction at the terminal 110 by, for example, reviewing the list of items to be purchased on display 162 and arranging for payment.

The present disclosure relates to a self-service checkout system that combines vision-based recognition technology with a produce pick list system. The self-service checkout terminal of the present disclosure provides a seamless transition between vision checkout for packaged items and pick list checkout for bulk produce. This integrated approach streamlines the checkout process by allowing customers to scan items visually while also facilitating the selection and weighing of produce items, enhancing user experience and operational efficiency. This approach provides a number of benefits, including, for example, reduced checkout time through automated item recognition, enhanced accuracy in produce pricing, and improved user satisfaction by minimizing manual input.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

1. A self-service checkout system, comprising:
a first computing device having a processor and a non-transitory computer-readable storage medium;
a set of at least two cameras coupled to the first computing device and having a respective predefined field of view focused on a scan zone, each of the at least two cameras providing a respective output image of the scan zone to the first computing device, each of the at least two cameras providing a different view of the scan zone;
a checkout tray within the scan zone; and
wherein the non-transitory computer-readable storage medium in the first computing device includes executable instructions that, when executed by the processor, cause the processor to:
forward the output images from each of the at least two cameras to a machine learning model trained to identify packaged items and suggested produce items to determine that an item placed on the checkout tray by a user during a transaction is a produce item or a packaged item;
when the item is the packaged item, receive from the machine learning model an identification of the packaged item, and add the identification of the packaged item to a list of items to be purchased; and
when the item is a produce item, receive from the machine learning model a list of suggested produce items, provide the list of suggested produce items to the user via a user interface, and, when the user selects an appropriate item from the list, add the produce item to the list of items to be purchased.

2. The self-service checkout system of claim 1, wherein the checkout tray has an integral scale coupled to the first computing device to provide a weight signal corresponding to a weight of any item positioned on the checkout tray.

3. The self-service checkout system of claim 2, wherein the non-transitory computer-readable storage medium in the first computing device includes executable instructions that, when executed by the processor, cause the processor to, when the item is a produce item, receive the weight signal from the integral scale.

4. The self-service checkout system of claim 3, wherein the non-transitory computer-readable storage medium in the first computing device includes executable instructions that, when executed by the processor, cause the processor to, when the item is a produce item and after the user selects an appropriate produce item, calculate a price for the selected produce item based on a stored unit price per weight for the selected produce item.

5. The self-service checkout system of claim 1, comprising:
a second computing device having a processor and a non-transitory computer-readable storage medium;
wherein the non-transitory computer-readable storage medium in the second computing device includes executable instructions that, when executed by the processor, cause the processor to:
generate the machine learning model based on training data stored in memory in the second computing device;
operate the machine learning model;
receive information for input to the machine learning model; and
forward output information from the machine learning model to the first computing device.

6. The self-service checkout system of claim 5, wherein the non-transitory computer-readable storage medium in the second computing device includes executable instructions that, when executed by the processor, cause the processor to generate the machine learning model based on training data stored in memory in the second computing device.

7. The self-service checkout system of claim 6, wherein the training data comprises images of produce items and packaged items.

8. The self-service checkout system of claim 5, wherein first computing device is located at a retail location and the second computing device is also located at the retail location.

9. The self-service checkout system of claim 5, wherein first computing device is located at a retail location and the second computing device is located remotely to the retail location.

10. The self-service checkout system of claim 1, wherein the user interface is a display.

11. A method of operating a self-service checkout system, comprising:
forwarding respective output images from each camera within a set of at least two cameras having a predefined field of view focused on a respective portion of a scan zone to a machine learning model trained to identify packaged items and suggested produce items to determine that an item placed on a checkout tray in the scan zone by a user during a transaction is a produce item or a packaged item, where each of the at least two cameras provide a different view of the scan zone;
when the item is a packaged item, receiving from the machine learning model an identification of the packaged item, and adding the identification of the packaged item to a list of items to be purchased; and
when the item is a produce item, receiving from the machine learning model a list of suggested produce items, providing the list of suggested produce items to the user via a user interface, and, when the user selects an appropriate item from the list, adding the selected produce item to the list of items to be purchased.

12. The method of claim 11, wherein the checkout tray has an integral scale to provide a weight signal corresponding to a weight of any item positioned on the checkout tray.

13. The method of claim 12, comprising, when the item is a produce item, receiving the weight signal from the integral scale.

14. The method of claim 13, comprising, when the item is a produce item and after the user selects an appropriate produce item, calculating a price for the selected produce item based on a stored unit price per weight for the selected produce item.

15. The method of claim 11, comprising generating the machine learning model based on training data stored in a memory.

16. The method of claim 15, wherein the training data comprises images of produce items and packaged items.
